(19) United States
(12) Patent Application Publication
(10) Pub. No.: US 2007/0123123 A1
(43) Pub. Date: May 31, 2007

(54) Anti insect screening

(76) Inventor: James V. Guffey, Ft. Myers, FL (US)

Correspondence Address: James V. Guffey, 6368 Emerald Pines Circle, Ft. Myers, FL, 33912, US

(21) Appl. No.: 11/286,403

(22) Filed: Nov. 25, 2005

(51) Int. Cl. B32B 5/02; D04H 1/08

(52) U.S. Cl. 442/59; 442/320

(57) ABSTRACT

An anti insect screening is made from composite based and thermosetting fibers or yarns that are constructed into a screen fabric wherein the yarns cross each other. The fabric with the yarns therein is heat set whereby the crossing yarns will adhere to each other. The thus obtained fabric is coated by a fluoropolymer based film. The anti insect screening is stretchable but will revert to its original state through the phenomenon of plastic memory. The anti insect screening is chemically inert and solvent resistant to substantially all chemicals. Its mechanical toughness demonstrates superior anti-stick and low frictional properties.

### FIELD OF THE INVENTION

The invention discloses screening material that is normally used in frames for windows, as pool enclosures and/or lanai enclosures. The screening is designed to prevent insects from entering the building or to protect outdoor areas and individuals therein from being accosted by insects.

### BACKGROUND OF THE INVENTION

Normally, insect screening is made by coating individual glass fiber yarns and then weaving these yarns to create a fabric which is heat set so that the points of contact in the warp and weft direction are fused together. This multi step process is complicated,.expensive and requires precise types of construction. The fabric is then dip coated in PVC.

Present construction of insect screening is an aging technology with many flaws. It doesn't meet the specific extreme needs of being strong, durable, safer and cleaner.

### BRIEF DESCRIPTION OF THE INVENTION

The aim of this invention is to create a new insect screening product for windows, doors, sun rooms, lanais and pool cages which does not exist on the market today. The screening material is lighter, stronger, safer and cleaner by using more modern polymers, thermosetting composites and polymer coatings that will improve all fabric and product performance attributes and mechanical properties. The screening product will save consumer costs during the life of the product through its construction attributes and blending of polymer technologies.

The new insect screens will add to superior construction techniques by increasing the strength of the material and by reducing wind friction and forces that are exerted on aluminum construction supports. Expensive repair and replacement costs are eliminated while reducing algae, mold and mildew growth through effective application of fiber coatings. Its performance in extreme weather conditions will be improved over typical common market insect screening. The inventive screening will perform in a superior fashion due the strength, elasticity and other modulus attributes of the fibers and coatings selected and integrated in its construction. This includes increased performance and wear in tropical storms or hurricane force winds, thus protecting lanais and pool cages. Extreme forces of lateral and vertical lift along with pressure area differentials on the inside and outside of the enclosures will be reduced if the inventive screening is employed.

### DETAILED DESCRIPTION OF THE INVENTION

The insect screening will incorporate therein fibers or yarns based on Aramid, Aramid Carbon or polymer based composite compositions or other polymer thermosetting composites as yarn fibers to be woven, knitted or otherwise fixed together through thermosetting resin technologies. The yarn is used to produce a screening by weaving, braiding, knitting or by laminating, The thus obtained fabric will be coated with PVC or Flouropolymer based film. It will be heat sealed, thermoformed, vacuum heat bonded, welded, metalized, laminated and used as hot melt adhesive.

The thus obtained screening will be stretchable in all direction, unlike known screens which are known to be non-stretchable. The stretch ability is based in the polymers used to construct the fabric. Of course, the stretch ability stays within certain limits because of the nature of where the screening is installed. Another feature of the stretch ability is, when a force is applied to the screening, it will give (stretch) but will immediately return to its original state because of the phenomenon of “plastic memory”. Such force could be created by someone leaning against the screen, high winds or other forces. The known screen materials could not withstand such forces but would tear. This does not include objects blown at the screening by high winds such as are created by hurricanes. The winds alone could not tear the screening.

Material Weights:

An all carbon fiber composite costs 3.5 times more than an all glass composite to provide the same structural stiffness at a weight savings of 76%. When a 50/50 glass carbon hybrid composite is used, however, the calculated cost ratio is reduced with a weight saving of about 58%. The results appear to be similar for glass and aramid composites.

Fabric Construction:

Thermosetting Composites. Polyester Fibers, E glass, S glass, Carbon fiber, metal fibers, Glass Composites or other Polymer Fibers Composites or Hybrids can use thermoplastic or thermosetting resins. Polymatrix composites included. Using any fiber yarns and then incorporating the same into a structure to create a fabric, which is then heat set or woven so that the points of contact in the warp or the weft direction or any applied pattern in any direction are fused together. The applied pattern includes non-wovens. The higher the numbers the tighter the construction of the fabric including the diameter of the yarns. 18×16, 18×14 and 20×20 are traditional. This is applicable for any construction.

Coatings:

PVC or NDG PVC are used primarily for outdoor applications where UV resistance and outdoor weather ability are primary concerns. These materials are usually available in both high and low volatility and in a wide range of colors. They are also available in several formula modifications depending on whether the end user is undertaking the coating. any coating thickness is applicable. A standard is 0.025 g.

Thermoplastic Film (PVA-PFA or ETEE Teflon) or Oriented Fluoropolymer films can be heat sealed, thermoformed, vacuum heat bonded, welded, metalized, laminated (combined with dozens of other materials), and used as a hot melt adhesive.
It has great chemical compatabilities. It is chemically inert and solvent resistant to virtually all chemicals, except molten metals, gaseous fluorine and halogenated compounds like chlorine triflorides.
It has excellent reliability and retention properties over large areas of film. There is no electrical activity, it is non-wettable and non-charring. Its mechanical toughness demonstrates superior anti-stick and low frictional properties.
Weather ability tests demonstrate that it is inert to any outdoor exposure and shows a high transmittance of ultra violet light, and other spectral light but infrared.
Reliability PFA film contains no plasticizers or other foreign materials. Conventional equipment and techniques can be used for processing and the basic composition will not be influenced. A quality control ensures uniform gauge and void free film
Mechanical toughness demonstrates a superior antistick and low frictional properties along with high resistance to impact and tearing and useful physical properties at cryogenic temperatures.

What I claim is:

1. An anti insect screening made of polymer composite based fibers, said fibers are constructed into a screen fabric whereby said fibers will cross each other, the screen fabric is coated with a polymer based film, said fabric is heat sealed by the melted polymer based film, whereby said crossing fibers will adhere to each other, the resulting fabric is stretchable but will return to its original state due to the phenomenon of plastic memory.

2. The anti insect screening of claim 1, wherein said polymer composite fibers are selected from the group consisting of Aramid and Aramid Carbon compounds.

3. The anti insect screening of claim 1, wherein said coating of polymer based film is selected from the group consisting of PVC, NDG PVC, and fluoro polymers.

4. The anti insect screening of claim 1, wherein said construction of said fabric is obtained by weaving.

5. The anti insect screening of claim 1, wherein said construction of said fabric is obtained by knitting.

6. The anti insect screening of claim 1, wherein said construction of said fabric is obtained through a non-woven technique.

7. The anti insect screening of claim 1 wherein said construction of said fabric is obtained by braiding.
